(19) United States
(12) Patent Application Publication
(10) Pub. No.: US 2014/0311381 A1
(43) Pub. Date: Oct. 23, 2014

(54) Cellulose Acylate Film

(71) Applicant: SK Innovation Co., Ltd., Seoul (KR)

(72) Inventors: Hyo Shin Kwak, Daejeon (KR); Min Joung Im, Daejeon (KR); Seung Eon Lee, Daejeon (KR); Tae Sug Jang, Daejeon (KR); Myoung Lae Kim, Daejeon (KR); Yong Gyun Cho, Daejeon (KR); Won Yeob Kim, Daejeon (KR); Min Sang Park, Daejeon (KR)

(73) Assignee: SK Innovation Co., Ltd., Seoul (KR)

(21) Appl. No.: 14/200,470

(22) Filed: Mar. 7, 2014

(30) Foreign Application Priority Data
Mar. 7, 2013 (KR) 10-2013-0024597

(51) Int. Cl. G02B 1/10

(52) U.S. Cl. CPC G02B 1/105
USPC 106/162.71; 536/69; 536/68

(57) ABSTRACT

Provided is a cellulose acylate film for an optical film usable for optical compensation sheet, an optical filter for stereoscopic images, a polarizer and a liquid crystal display and the like.

### TECHNICAL FIELD

The following disclosure relates to a cellulose acylate film, and more particularly, to a cellulose acylate film for an optical film usable for optical compensation sheet, an optical filter for stereoscopic images, a polarizer and a liquid crystal display and the like.

### BACKGROUND

Since a liquid crystal display has a narrow viewing angle, when it is viewed at an oblique angle from its front side, the image quality of displayed information is low so that the recognition rate is lowered, or especially in a dark state, true black is not achieved due to a light leak. In particular, in VA (Vertical Alignment) mode LCD, the liquid crystals within a liquid crystal cell have naturally different phase differences of one another depending on viewing angles. Thus, image distortion is high depending on the viewing angle.

Therefore, unless an optical compensation structure to which retardation film is applied, is not introduced, a contrast ratio is dropped due to a light leak in a viewing angle, and it is hard to obtain a clear image. In addition, color characteristic is influenced, so that an unclear and low grade image is produced. Recently, especially as LCD video display terminal is applied to a television at home or a home theater, the image quality at a viewing angle is increasingly important.

Currently, a liquid crystal used in various LCD modes mostly shows a high birefringence for low wavelength light, and as the wavelength of a light increases, the birefringence of liquid crystal tends to decrease, which is called “normal dispersion” birefringence. Since the birefringence of liquid crystal used in LCD has normal dispersion, a film compensating the retardation change of a light passing through a liquid crystal cell is required to have an “inverse dispersion” retardation. In particular, in VA mode LCD, the liquid crystal is vertically aligned, so that the retardation change in a thickness direction is large. The compensation film to be applied for compensation thereof should have a retardation in a thickness direction (Rₜₕ) similar to a phase retardation value generated when passing through a liquid crystal cell, and also “inverse dispersion” as wavelength dispersion so as to compensate for “normal dispersion”.

Japanese Patent Laid-Open Publication No. 2000-137116 discloses a film containing cellulose acetate as a single inverse wavelength dispersion film. The patent document recites the inverse dispersion of in-plane retardation of film, but not a retardation in a thickness direction. The invention of the patent document is used for preventing reflection of external light, and it does not compensate for phase delay of light passing through a liquid crystal cell, but if external light passing through a top polarizer and a compensate film in turn is reflected by a glass substrate of a liquid crystal cell and passes through the compensate film again, phase delay by ½λ of light first passing through top polarizer is generated, and light does not pass through a top polarizer and is entirely absorbed. Therefore, the use of the patent document is different from that of the optical film of the present invention.

Generally, a cellulose acylate resin used in an optical film has a substitution degree of 2.7. If a cellulose acylate film of a substitution degree less than 2.6, more specifically less than 2.45 is used, an optical film having high Rₜₕ and Rₜₕ inverse dispersion required for a compensate film for VA-mode LCD may be manufactured, but the film has high water vapor transmission rate to generate a problem in moisture resistance of the film. However, if a cellulose acylate having high substitution degree is used, hydroxyl group which is a polar group decreases, so that sufficient anisotropy (retardation) may not be expressed. In order to solve such problems, a retardation regulator may be added as a material enabling increase of a phase difference. Since such retardation regulator mostly represents normal dispersion, if its content increases, inverse dispersion may not be achieved.

In an optical film, especially an optical film for VA mode, such phase difference should represent inverse dispersion. In the conventional manufacture of cellulose acylate film, effort to maintain inverse wavelength dispersion is continued by using cellulose acylate film having a substitution degree of 2.7 or more so that a retardation regulator is contained as little as possible.

However, it has never been investigated to manufacture an optical film having inverse wavelength dispersion, together with excellent water vapor transmission rate, using cellulose acylate resin having a substitution degree less than 2.6, more specifically of 2.45 or less.

### RELATED ART DOCUMENT

### Patent Document

Japanese Patent Laid-Open Publication No. 2000-137116 (May 16, 2000)

### SUMMARY

An embodiment of the present invention is directed to providing a cellulose acylate film having low water vapor transmission rate, together with high retardation in a thickness direction and representing inverse wavelength dispersion, using cellulose acylate resin having a low substitution degree.

Another embodiment of the present invention is directed to providing an optical film usable as a polarizer protective film, that is, a cellulose acylate film having water vapor transmission rate satisfying the physical properties required in an optical film, and also retardation capable of expressing inverse wavelength dispersion.

Another embodiment of the present invention is directed to providing a cellulose acylate film having excellent mechanical properties, and small mass change after heat treatment at high temperature less than 5%.

In one general aspect, a cellulose acylate film includes a cellulose acylate resin having a substitution degree of hydroxyl group of 2.0 to 2.6 per 1 unit of cellulose, and has a water vapor transmission rate of 70,000 g·μm/m²·day or less, and a retardation in a thickness direction (Rₜₕ(λ)) satisfying the following Equation 1:

100<Rₜₕ(550)<300 [Equation 1]

wherein, Rₜₕ(λ) is a retardation value (nm) in the direction of the film thickness at a wavelength of λnm.

The cellulose acetate film may be used in optical compensation sheet, an optical filter for stereoscopic images, a polarizer and a liquid crystal display.

In another general aspect, a display includes the cellulose acetate film.

Other features and aspects will be apparent from the following detailed description, and the claims.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the constitution of the present invention will be more specifically described.

An embodiment of the present invention relates to a cellulose acylate film including a cellulose acylate resin having a substitution degree of hydroxyl group of 2.0-2.6 per 1 unit of cellulose, having a water vapor transmission rate of 70,000 g·μm/m²-day or less, and a retardation in a thickness direction (Rₜₕ(λ)) satisfying the following Equation 1:

100<Rₜₕ(550)<300 [Equation 1]

wherein, Rₜₕ(λ) is a retardation value (nm) in the direction of the film thickness at a wavelength of λnm.

In an embodiment of the present invention, the cellulose acylate film is suitable for being used in VA-mode, and it is preferred that the retardation in a thickness direction (Rₜₕ(λ)) satisfies the range of the above Equation 1, so that the film may represent inverse wavelength dispersion.

In addition, in an embodiment of the present invention, the retardation in a thickness direction (Rₜₕ(λ)) may satisfy the following Equation 2:

Rₜₕ(650)/Rₜₕ(550)>1

Rₜₕ(550)−Rₜₕ(650)<Rₜₕ(550)−Rₜₕ(450) [Equation 2]

wherein, Rₜₕ(λ) is a retardation value (nm) in the direction of the film thickness at a wavelength of λnm.

In an embodiment of the present invention, the cellulose acylate resin is ester of cellulose and acetic acid, and hydrogen atoms of hydroxyl groups present at 2-, 3- and 6-positions of a glucose unit constituting a cellulose may be entirely or partially substituted by any one or two or more selected from acetyl group, propionyl group and butyryl group. The range of molecular weight of cellulose acylate resin is not limited, but preferably in the range of 200,000-350,000. In addition, the molecular weight distribution Mw/Mn (Mw is weight average molecular weight, and Mn is number average molecular weight) of cellulose acylate resin is preferably 1.4-1.8, more preferably 1.5-1.7.

In an embodiment of the present invention, the substitution degree of cellulose acylate resin may be 2.0 or more, specifically 2.0-2.6, more specifically 2.2-2.45. In addition, the substitution degree of the cellulose acylate resin may satisfy the following Equation 3. The substitution degree may be measured according to ASTM D-817-91.

2.2≦DSac+DSap+DSab≦2.45 [Equation 3]

wherein, DSac is a substitution degree of acetyl group, DSap is a substitution degree of propionyl group, and DSab is a substitution degree of butyryl group.

In the above range of the substitution degree, alcohol groups in the resin are bonded to each other within the resin to unidirectionally form bonds, and thus, phase difference in the direction of the film thickness (Rₜₕ) may be increased, and as the wavelength is longer, inverse dispersion with greater phase difference may be represented. The present invention is characterized by providing film having water vapor transmission rate appropriate for an optical film, and inverse wavelength dispersion, using the cellulose acylate resin having the above range of substitution degree. Generally, the higher the substitution degree of cellulose acylate resin is, the lower the water vapor transmission rate tends to be. By addition of a retardation additive, the retardation in a thickness direction may be regulated, and the water vapor transmission rate may be further lowered. However, in case of increased content of the retardation additive, inverse wavelength dispersion may be lowered, or normal dispersion may be represented.

Moreover, in case of using cellulose acylate resin having a low substitution degree of 2.6 or less, the water vapor transmission rate is very high. Though large amount of retardation additive is added in order to lower the water vapor transmission rate, it is difficult to lower the water vapor transmission rate 70,000 g·μm/m²·day or less which is usable for an optical film. In case of using too much amount of additive, inverse wavelength dispersion may be lowered, or normal dispersion may be represented. In addition, mechanical properties of the film may be deteriorated.

As a result of measurement of the water vapor transmission rate, the present inventors found out that the cellulose acetate film having a substitution degree of 2.4 has very high water vapor transmission rate of 180,000 g·μm/m²·day.

The inventors studied to provide cellulose acylate film having water vapor transmission rate of 70,000 g·μm/m²·day or less, using cellulose acylate resin having a low substitution degree. In the range of water vapor transmission rate of 70,000 g·μm/m²·day or less, low water vapor transmission rate will be advantageous to a polarizer protective effect when applied to an optical film. However, since water-based joining is generally used to join the cellulose acylate protective film and the polarizer, water should be somewhat passed through the film to discharge water remained between the polarizer and the protective film without any problem. Therefore, in the range of the water vapor transmission rate of preferably 70,000 g·μm/m²·day or less, more preferably 40,000-60,000 g·μm/m²·day, the optical film protecting a polarizer and without any problem after water-based joining may be provided.

If cellulose acylate resin having a substitution degree of 2.0-2.6 is contained, inverse dispersion may not be affected by relatively increased content of an additive. However, it had been found out that, as the substitution degree is lowered, the interaction of hydroxyl group of cellulose and water increases, thereby making it difficult to control the water vapor transmission rate to the above range.

Accordingly, the present inventors studied to overcome such problems, and as a result, have discovered that film having excellent retardation in a thickness direction to be appropriate for VA-mode, representing inverse wavelength dispersion, and simultaneously having low water vapor transmission rate may be provided by using a retardation regulator of any one or more selected from the following Chemical Formula 1, as a material capable of both giving optical anisotropy and controlling water vapor transmission rate, and completed the present invention.

More preferably, the film satisfying all physical properties to be desired may be manufactured by using 10-50 parts by weight, more preferably 10-20 parts by weight of a retardation regulator of any one or more selected from the following Chemical Formula 1, based on 100 parts by weight of cellulose acylate resin.

In an exemplary embodiment of the present invention, any one or more compounds selected from the following Chemical Formula 1 may be used as the retardation regulator:

Ar—[Q]ₘ [Chemical Formula 1]

wherein,

Ar is (C6-C20)aryl or (C3-C20)heteroaryl, and may be further substituted by one or more selected from halogen, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group, (C6-C20)aryloxycarbonyl group, (C1-C20)alkylacyloxy group, (C6-C20)arylacyloxy group, sulfonylamino group, nitro, hydroxyl group, cyano group, amino group, acylamino group, and 5- to 7-membered heterocycloalkyl containing one or more elements selected from Q, N, O and S;

Q is

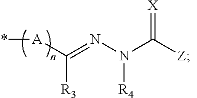

A is

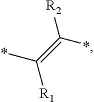

wherein R₁ and R₂ are hydrogen, halogen, hydroxy, (C1-C20)alkyl or (C3-C20)heterocycloalkyl, respectively;

R₃ is hydrogen, halogen, hydroxy, (C1-C20)alkyl, (C1-C20)alkylcarbonyl, (C6-C20)allyl, (C3-C20)heteroaryl or (C3-C20)heterocycloalkyl, and R₃ and Ar may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

R₄ is hydrogen or (C1-C20)alkyl;

X is O or S;

Z is (C1-C20)alkyl group, —N(R₁₁R₁₂) or —O(R13), wherein R₁₁ to R₁₃ are independently of one another selected from hydrogen, (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

n is an integer of 0 to 3;

m is an integer of 1 to 10; and

alkyl and heterocycloalkyl of R₁ to R₃, alkyl of R₄, alkyl of Z, alkyl of R₁₁ to R₁₃, and alicyclic ring or aromatic ring of Z and R₃ may be independently of one another further substituted by one or more selected from halogen, nitro, cyano, hydroxy, amino, (C1-C20)alkyl, (C1-C20)alkoxy, (C2-C20)alkenyl, (C3-C20)cycloalkyl, 5- to 7-membered heterocycloalkyl containing one or more elements selected from N, O and S.

“Alkyl”, “alkoxy” and other the substituent containing “alkyl” part include both straight chained- and branched types, and “cycloalkyl” includes not only monocyclic hydrocarbons, but also various polycyclic hydrocarbons such as substituted or unsubstituted adamantyl or substituted or unsubstituted (C7-C20)bicycloalkyl.

Aryl or heteroaryl of Ar in the Chemical Formula 1 may have identical or different plural substituents besides Q except for the compound in which Q is substituted by OR in ortho position, wherein R is hydrogen or (C1-C20)alkyl. That is, aryl or heteroaryl of Ar in the Chemical Formula 1 may be substituted or unsubstituted aryl, or substituted or unsubstituted heteroaryl, but is necessarily aryl or heteroaryl in which Q is mono- or polysubstituted.

In the Chemical Formula 1 according to an exemplary embodiment of the present invention, Ar may be further substituted by one or more selected from halogen, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group, (C6-C20)aryloxycarbonyl group, (C1-C20)alkylacyloxy group, (C6-C20)arylacyloxy group, sulfonylamino group, nitro, hydroxyl group, cyano group, amino group, acylamino group, and 5- to 7-membered heterocycloalkyl containing one or more elements selected from Q, N, O and S;

R₁ and R₂ are hydrogen, respectively;

R₃ is hydrogen, (C1-C20)alkyl or (C1-C20)alkylcarbonyl;

R₄ is hydrogen or (C1-C20)alkyl;

X is O or S;

Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

n is an integer of 0 to 3;

m is an integer of 1 to 10; and

alkyl and heterocycloalkyl of R₁ to R₃, alkyl of R₄, alkyl of Z, and alkyl of R₁₁ to R₁₃ may be independently of one another further substituted by one or more selected from halogen, nitro, cyano, hydroxy, amino, (C1-C20)alkyl, (C1-C20)alkoxy, (C2-C20)alkenyl, (C3-C20)cycloalkyl, 5- to 7-membered heterocycloalkyl containing one or more elements selected from N, O and S.

Specifically, the compound of the Chemical Formula 1 according to an exemplary embodiment of the present invention may be represented by the compounds of the following Chemical Formulae 2 and 3:

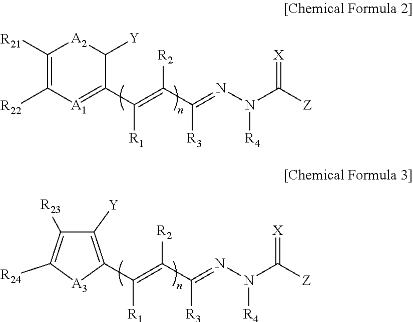

wherein,

R₁ and R₂ are hydrogen, halogen, hydroxy, (C1-C20) alkyl or (C3-C20)heterocycloalkyl, respectively;

R₃ is hydrogen, halogen, hydroxy, (C1-C20)alkyl or (C3-C20)heterocycloalkyl, and R₃ and Ar may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

R₄ is hydrogen or (C1-C20)alkyl;

X is O or S;

Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

n is an integer of 0 to 3;

A₁ or A₂ are independently of each other CR₇ or N;

A₃ is O, S or NR₈, wherein R₈ is hydrogen or (C1-C20)alkyl;

Y is selected from hydrogen, —N(R₃₁R₃₂), —O(R₃₃), —S(R₃₄) or —P═O(R₃₅) (R₃₆), wherein R₃₁ to R₃₆ are independently of one another hydrogen or (C1-C20)alkyl; and

R₂₁ to R₂₄ and R₇ are independently of one another selected from hydrogen, halogen, Q, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group (C6-C20)aryloxycarbonyl group, (C1-C20)alkylacyloxy group, (C6-C20)arylacyloxy group, sulfonylamino group, hydroxyl group, cyano group, amino group, acylamino group and 5- to 7-membered heterocycloalkyl containing one or more elements selected from N, O and S.

More specifically, in the above Chemical Formulae 2 and 3,

R₁ and R₂ are hydrogen, respectively;

R₃ is hydrogen, (C1-C20)alkyl or (C1-C20)alkylcarbonyl;

R₄ is hydrogen or (C1-C20)alkyl;

X is O or S;

Z is (C1-C20)alkyl group, —N(R₁₁R₁₂) or —O(R₁₃), wherein R₁₁ to R₁₃ are independently of one another selected from hydrogen, (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;

n is an integer of 0 to 3;

A₁ or A₂ are independently of each other CR₇ or N;

A₃ is O, S or NR₈, wherein R₈ is hydrogen or (C1-C20)alkyl;

Y is selected from hydrogen, —N(R₃₁R₃₂), —O(R₃₃), —S(R₃₄) or —P═O(R₃₅) (R₃₆), wherein R₃₁ to R₃₆ are independently of one another hydrogen or (C1-C20)alkyl; and

R₂₄ to R₂₄ and R₇ are independently of one another selected from hydrogen, halogen, Q, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group (C6-C20)aryloxycarbonyl group, (C1-C20)alkylacyloxy group, (C6-C20)arylacyloxy group, sulfonylamino group, hydroxyl group, cyano group, amino group, acylamino group and 5- to 7-membered heterocycloalkyl containing one or more elements selected from N, O and S.

More specifically, the Chemical Formula 1 may be selected from the following structures, but not limited thereto:

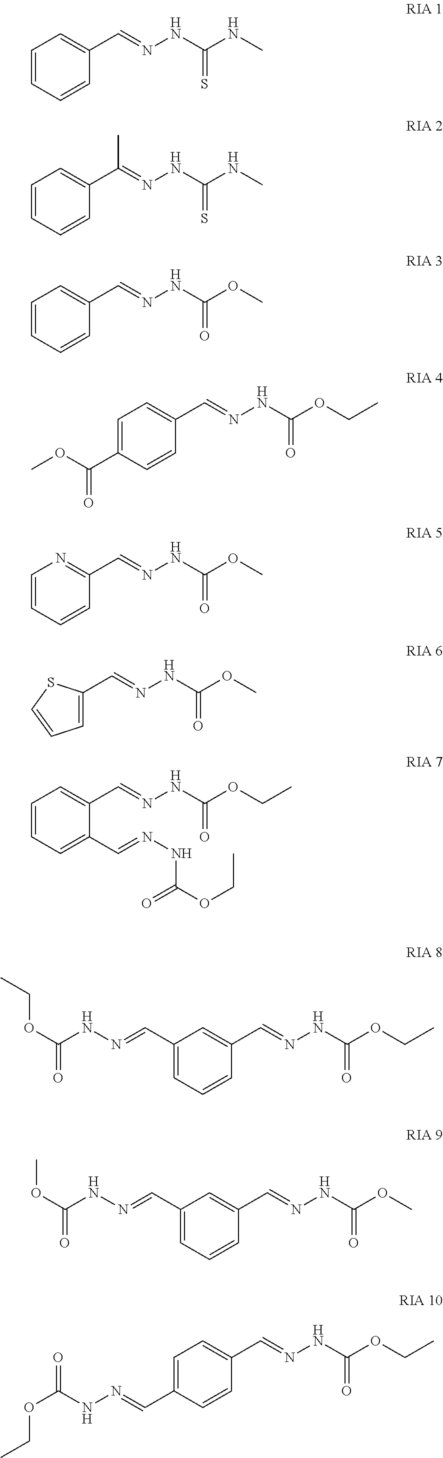

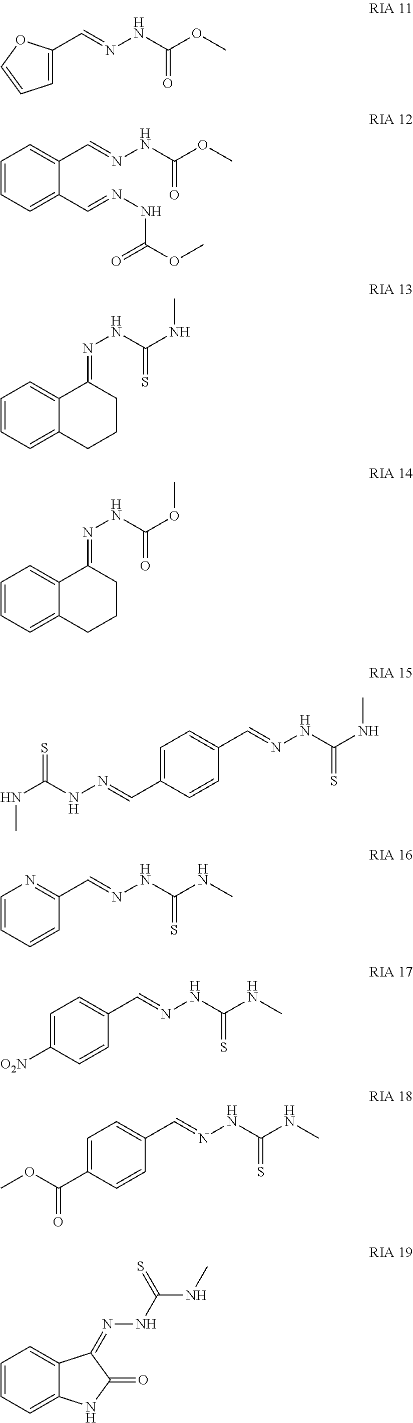

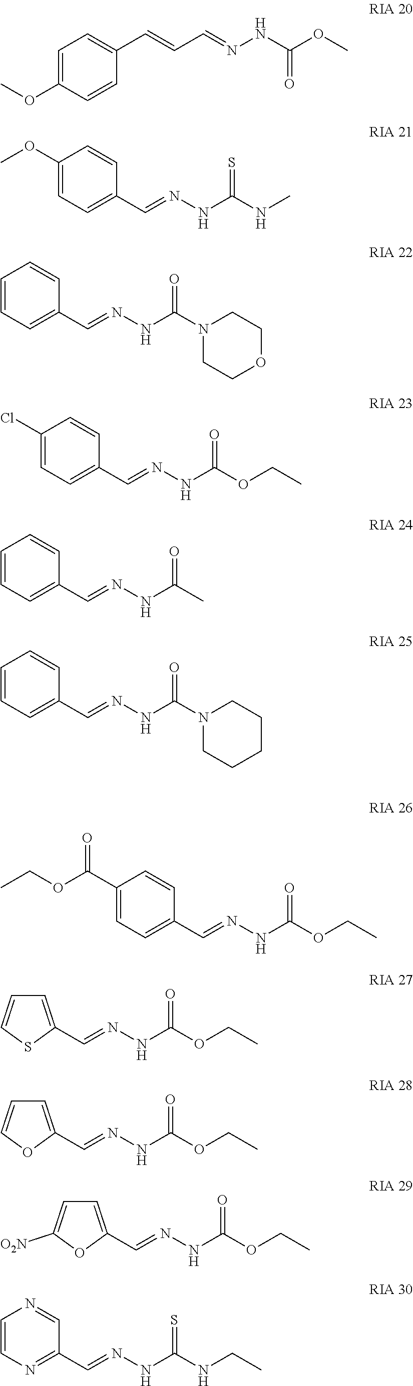

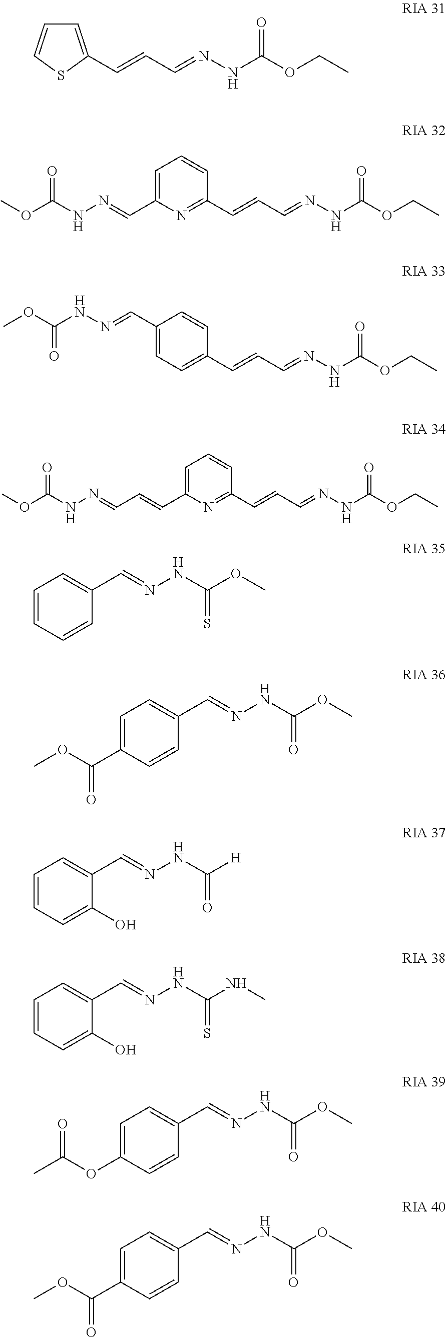

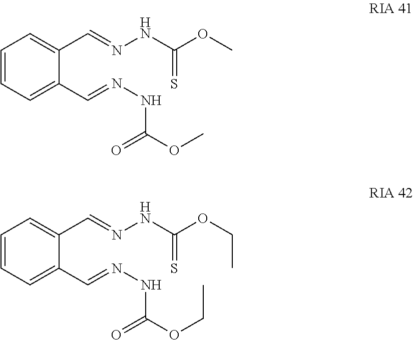 [SMILES: COC(=O)N/N=C/c1ccccc1/C=N/NC(=S)OC ; CCOC(=O)N/N=C/c1ccccc1/C=N/NC(=S)OCC]

The compound of the above Chemical Formula 1 may be prepared as indicated in the following Reaction Formula 1, but the preparation process of the compound of Chemical Formula 1 is not limited thereto, and the modification thereof is evident to a person skilled in the art.

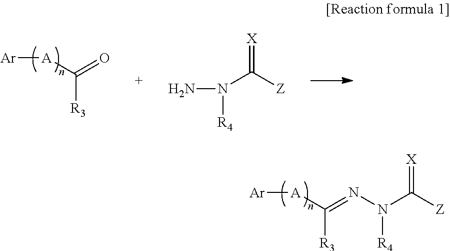

wherein,

A, R₃, R₄, X, Y and Z are as defined in the above Chemical Formula 1.

In an embodiment of the present invention, the compound of the above Chemical Formula 1 may have a molecular weight of 300-1000. The physical properties to be desired may be satisfied within such range of the molecular weight.

In addition, the film of the present invention containing the above retardation regulator may satisfy the physical property of mass change less than 5% after heat treatment at 110° C. for 500 hours. Within the range of mass change less than 5%, long term storage stability is excellent, and aging may be prevented.

In an embodiment of the present invention, the above cellulose acylate film may further contain any one or two or more additives selected from ultraviolet inhibitor, fine particles, a plasticizer, a deterioration inhibitor, a releasing agent, an infrared absorbing agent, and optical anisotropy controlling agent.

In an embodiment of the present invention, it is preferred to manufacture the cellulose acylate film by a solvent cast method using a cellulose acylate dope solution. The solvent cast method is to cast a solution (dope) in which cellulose acylate is dissolved in a solvent on a support, and evaporate the solvent to form a film.

As a raw material of cellulose acylate dope solution, cellulose acylate particles are preferably used. In this case, it is preferred that 90% by weight or more of the cellulose acylate particles have an average particle diameter of 0.5 to 5 mm. In addition, it is preferred that 50% by weight or more of cellulose acylate particles have an average particle diameter of 1 to 4 mm.

It is preferred that cellulose acylate particles are as round as possible. It is also preferred that the cellulose acylate particles are dried to have moisture content of 2% by weight or less, more preferably 1% by weight or less, then the dope solution is prepared.

Next, the additive used in cellulose acylate film will be described.

To cellulose acylate solution (dope) used in the solvent cast method, various additives such as for example, a plasticizer, an ultraviolet inhibitor, a deterioration inhibitor, fine particles, release agent, infrared absorbing agent, optical anisotropy controlling agent may be added according to their uses in each preparation process. The specific kinds of such additives may not be limited as long as they are conventionally used in the art. The time to add the additive is determined depending on its kind. The additive may be added at the end of the preparation of the dope.

The plasticizer is used for improving mechanical strength of film, and may shorten the drying process time of film if used. As the plasticizer, any conventionally used one may be used without limitation, for example, phosphoric acid ester and carboxylic acid ester selected from phthalic acid ester or citric acid ester. As phosphoric acid ester, triphenyl phosphate (TPP), biphenyldiphenyl phosphate and tricresyl phosphate (TCP), and the like may be mentioned. As phthalic acid ester, dimethyl phthalate (DMP), diethyl phthalate (DEP), dibutyl phthalate (DBP), dioctyl phthalate (DOP), diphenyl phthalate (DPP) and diethylhexyl phthalate (DEEP), and the like may be mentioned. As citric acid ester, o-acetyltriethyl citrate (OACTE) and o-acetyltributyl citrate (OACTB), and the like may be mentioned. As other examples of carboxylic acid ester, butyl oleate, methylacetyl lysine oleate, dibutyl sebacate, and various trimelitic acid esters may be mentioned. It is preferred that phthalic acid ester (DMP, DEP, DBP, DOP, DPP, DEHP) plasticizer is used. The content of the plasticizer is 2-20 parts by weight, more preferably 5-15 parts by weight, based on 100 parts by weight of cellulose acetate.

As the ultraviolet inhibitor, hydroxybenzophenone-based compound, benzotriazole-based compound, salicylic acid ester-based compound, cyanoacrylate-based compound, and the like may be used. The amount of the ultraviolet inhibitor is 0.1-3 parts by weight, more preferably 0.5-2 parts by weight, based on 100 parts by weight of cellulose acetate.

As the deterioration inhibitor, for example, antioxidant, peroxide decomposer, a radical inhibitor, a metal deactivator, an oxygen scavenger, light stabilizer (hindered amine, etc.), and the like may be used. As especially preferred example of the deterioration inhibitor, butylated hydroxytoluene (BHT) and tribenzylamine (TBA) may be mentioned. The amount of the deterioration inhibitor is 0.01-5 parts by weight, more preferably 0.1-1 parts by weight, based on 100 parts by weight of cellulose acetate.

The fine particles are added in order to satisfactorily maintain anti-curling of film, conveyability, anti-adhesion or scratch resistance in roll form, and any particles selected from inorganic compound or organic compound may be used. For example, as an inorganic compound, silicon-containing compound, silicon dioxide, titanium oxide, zinc oxide, aluminum oxide, barium oxide, zirconium oxide, strontium oxide, antimony oxide, tin oxide, tin.antimony oxide, calcium carbonate, talc, clay, calcined kaolin, calcined calcium silicate, hydrous calcium silicate, aluminum silicate, magnesium silicate, calcium phosphate, and the like are preferred, and more preferably, inorganic compound containing silicon or zirconium oxide, and the like may be used. The fine particles have an average primary particle diameter of 80 nm or less, preferably 5-80 nm, more preferably 5-60 nm, particularly preferably 8-50 nm. If average primary particle diameter is above 80 nm, the surface smoothness of film may be impaired.

In addition, if necessary, an optical anisotropy controlling agent, a wavelength dispersion adjusting agent, and the like may be further added. Such additives may be used without limitation, if it is generally used in the art.

In addition, the present invention provides an optical film prepared by a composition for an optical film according to the present invention. Such optical film may be used in optical compensation sheet, an optical filter for stereoscopic images, a polarizer and a liquid crystal display.

Next, the manufacturing method of the cellulose acylate film of the present invention will be described.

To manufacture the cellulose acylate film in the present invention, the following cellulose acylate composition, that is, a dope solution is prepared.

The cellulose acylate composition according to an exemplary embodiment of the present invention contains 10-parts by weight of the retardation regulator of the Chemical Formula 1, based on 100 parts by weight of cellulose acylate resin.

The solid content concentration of a dope in the present invention is preferably 15-25% by weight, more preferably 16-23% by weight. If the solid content concentration of a dope is less than 15% by weight, flowability is so high that film is difficult to be formed, and if it is above 25% by weight, complete dissolution may be difficult.

In an embodiment of the present invention, the content of cellulose acylate is 70% by weight or more, preferably 70-90% by weight, more preferably 80-85% by weight, based on the total solid content. Furthermore, the cellulose acylate may be used by mixing two kinds of cellulose acylate with different substitution degrees, polymerization degrees, or molecular weight distributions.

The retardation regulator according to an embodiment of the present invention may be used in the range of 10-50 parts by weight, based on 100 parts by weight of cellulose acetate. Within such range, phase difference range, water vapor transmission rate, and storage stability to be desired may be achieved.

In case of manufacturing the film by the solvent casting method, an organic solvent is preferred for preparing the cellulose acylate composition (dope). As an organic solvent, hydrocarbon halide is preferred to be used. As hydrocarbon halide, chlorinated hydrocarbon, methylene chloride and chloroform may be mentioned, and among these, methylene chloride is most preferably used.

Otherwise, if necessary, an organic solvent other than hydrocarbon halide may be mixed to be used. As the organic solvent other than hydrocarbon halide, ester, ketone, ether, alcohol and hydrocarbon are included. As esters, methyl formate, ethyl formate, propyl formate, pentyl formate, methyl acetate, ethyl acetate, pentyl acetate, and the like may be used. As ketones, acetone, methyl ethyl ketone, diethyl ketone, diisobutyl ketone, cyclopentanone, cyclohexanone, methyl cyclohexanone, and the like may be used. As ethers, diisopropyl ether, dimethoxy methane, dimethoxy ethane, 1,4-dioxane, 1,3-dioxolane, tetrahydrofuran, anisole, penetol, and the like may be used. As alcohols, methanol, ethanol, 1-propanol, 2-propanol, 1-buthanol, 2-buthanol, t-buthanol, 1-pentanol, 2-methyl-2-buthanol, cyclohexanol, 2-fluoroethanol, 2,2,2-trifluoroethanol, 2,2,3,3-tetrafluoro-1-propanol, and the like may be used.

More preferably, methylene chloride may be used as a main solvent, and alcohol as a sub solvent.

Specifically, methylene chloride and alcohol may be used in a mixed weight ratio of 80:20-95:5.

The cellulose acylate composition may be prepared according to room temperature, high temperature, or low temperature dissolution method.

The viscosity of the cellulose acylate composition is preferably 1 to 400 Pa·s at 40° C., more preferably 10 to 200 Pa·s.

The cellulose acylate film may be manufactured according to a conventional solvent casting method. More specifically, the prepared dope (cellulose acylate composition) is once stored in a reservoir, and defoamed. The defoamed dope is sent from a dope outlet to a pressurized type die through a pressurized type quantitative gear pump capable of quantitatively feeding liquid with high precision according to the rotation number, and evenly cast on a metal support endlessly running from slot (slit) of the pressurized type die, thereby peeling the less dried casting film from the metal support at the peeling point where the support metal almost makes a round. Both ends of the prepared web are clipped to maintain the width, and the web is returned to a tenter to be dried, then returned to a roller in a drying equipment to be dried, and wound in predetermined length by a winding machine. In addition, in the casting film manufacture, in the state of 10-40% by weight of the residual amount of the solvent, uniaxial and biaxial drawings in the mechanical and width directions are also possible. Otherwise, offline drawing after the manufacture of the casting film is also possible. Elongation is preferably in the range of 0-100%, more preferably in the range of 7-50%, most preferably in the range of 10-30%.

The space temperature in the application of the solution is preferably −50 to 50° C., more preferably −30 to 40° C., most preferably −20 to 30° C. The cellulose acetate solution applied at low space temperature is instantaneously cooled on the support to improve gel strength, and thus, a film on which an organic solvent is much remained is obtained. Therefore, the film may be peeled from the support in a short time, without evaporating the organic solvent from cellulose acylate. As a space-cooling gas, conventional air, nitrogen, argon, or helium may be used. The relative humidity is preferably 0 to 70%, more preferably 0 to 50%.

The temperature of the support (casting part) to be applied by the cellulose acylate solution is preferably −50 to 130° C., more preferably −30 to 25° C., most preferably −20 to 15° C. In order to cool the casting part, a gas cooled by the casting part may be introduced. By arranging a cooling system on the casting part, the space may be cooled. In cooling, it is important to be careful not to attach water on the casting part. In case of cooling by gas, it is preferred to dry gas in advance.

In addition, if necessary, cellulose acylate film may be surface-treated. Surface treatment is, generally, carried out in order to improve the adhesion of cellulose acylate film. As a surface treatment method, glow discharge treatment, ultraviolet irradiation treatment, corona treatment, flame treatment, saponification treatment and the like may be mentioned.

The thickness of the cellulose acylate film is preferably in the range of 20-140 μm, more preferably in the range of 40-100 μm.

The cellulose acylate film according to the present invention may be used in a polarizer, optical compensation sheet, an optical filter for stereoscopic images, and a liquid crystal device, and used in the laminated form in one piece or two pieces or more. The liquid crystal display is preferably in VA mode.

Hereinafter, Examples are provided for illustrating the present invention. However, the present invention is not limited to the Examples below.

Hereinafter, the physical properties of the film were measured by the following measuring methods.

1) Optical Anisotropy

Re was measured by incident lights of 450 nm, 550 nm, and 650 nm wavelengths in the normal direction of the film in a birefringence meter (Axoscan, Axometrics, Inc.). Rₜₕ is a value calculated from the following equation using three refractive index components of refractive index ellipsoid obtained by measuring the refractive indexes of lights of 550 nm, respectively in 10 degree intervals from 0 to 50 degrees to the normal direction of the film, using a slow axis within plane Re as a tilt axis:

Rₜₕ=[(nx+ny)/2−nz]×d

nx: the refractive index in the direction of larger one of the two refractive indexes of the plane

ny: the refractive index in the direction of smaller one of the two refractive indexes of the plane

nz: the refractive index in a thickness direction

d: the thickness of the film

2) Substitution Degree

The substitution degree was measured according to ASTM D-817-91.

3) Water Vapor Transmission Rate

It was measured in a water vapor transmission rate meter (PERMATRAN-W Model 3/33, MOCON). The moisture content passed through the film from an outer cell and permeated to an inner cell was measured under the condition of 760 mmHg of pressure, 37.8° C. of temperature, 100% of RH (relative humidity) of the outer cell, and N₂ carrier gas.

4) Storage Stability (Mass Change)

The storage stability was evaluated by preparing a film specimen having the size of 10 cm×10 cm (width and length), heat-treating it at 110° C. for 500 hours, and then measuring its mass change.

Mass change (%)={(mass of pre-treated film−mass of film after heat-treated at 110° C. for 500 hours)/mass of pre-treated film}×100 [Equation 4]

### Example 1

25 g of cellulose triacetate resin having a substitution degree of 2.4 was dissolved in a mixed solvent of 138 g of methylene chloride and 6 g of methanol, 2.5 g of the following retardation regulator (1) was added to be dissolved therein, and then the solution was rolling-stirred for 12 hours.

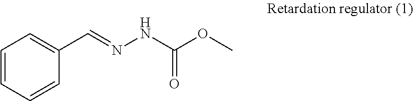

The prepared dope was cast on a glass plate, dried at room temperature for 7 minutes, then the formed cellulose acetate film was peeled from the glass plate, and dried at 140° C. for 60 minutes. Through the drying process, the residual solvent was evaporated to 0.5% by weight or less.

The obtained cellulose acetate film had the dried thickness of 60 μm, and its retardation, water vapor transmission rate and storage stability were evaluated and described in the following Table 1.

### Example 2

Film was prepared by the same method as Example 1, except for using 14 parts by weight of the retardation regulator (1). The retardation, water vapor transmission rate and storage stability of the prepared film were evaluated and described in the following Table 1.

### Example 3

Film was prepared by the same method as Example 1, except for using 20 parts by weight of the retardation regulator (1). The retardation, water vapor transmission rate and storage stability of the prepared film were evaluated and described in the following Table 1.

### Example 4

Film was prepared by the same method as Example 1, except for using 10 parts by weight of the following retardation regulator (2). The retardation, water vapor transmission rate and storage stability of the prepared film were evaluated and described in the following Table 1.

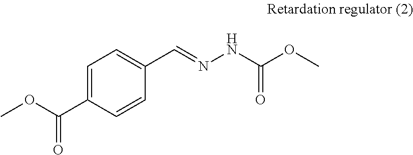

### Example 5

Film was prepared by the same method as Example 1, except for using 13 parts by weight of the following retardation regulator (3). The retardation, water vapor transmission rate and storage stability of the prepared film were evaluated and described in the following Table 1.

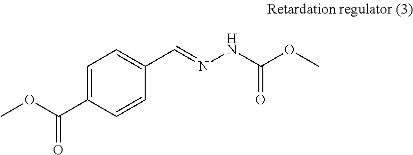

### Example 6

Film was prepared by the same method as Example 1, except for using 14 parts by weight of the following retardation regulator (4). The retardation, water vapor transmission rate and storage stability of the prepared film were evaluated and described in the following Table 1.

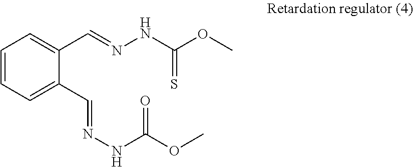 [SMILES: COC(=O)N/N=C/c1ccccc1/C=N/NC(=S)OC]

### Comparative Example 1

25 g of cellulose triacetate resin having a substitution degree of 2.78 was dissolved in 138 g of methylene chloride and 6 g of methanol, 3.75 g (15 parts by weight to 100 parts by weight of the resin) of the above retardation regulator (1) was added to be dissolved therein, and then the solution was rolling-stirred for 12 hours. Film was prepared by the same method as Example 1. The retardation, water vapor transmission rate and storage stability of the prepared film were evaluated and described in the following Table 1.

### Comparative Example 2

Film was prepared by the same method as Example 1, except for not containing a retardation additive, and its physical properties were measured, and described in the following Table 1.

TABLE 1

| | Substitution | | | Water vapor | | | | |
|---|---|---|---|---|---|---|---|---|
| | degree of | Type of | Content of | transmission | | | | Mass |
| | cellulose | retardation | retardation | rate (g · μm/ | | | Rₜₕ(650)/ | change |
| | acetate resin | regulator | regulator | m² · day) | Rₜₕ(450) | Rₜₕ(550) | Rₜₕ(550) | (%) |
| Example 1 | 2.4 | retardation | 10 parts | 65443 | 116.7 | 122.5 | 1.02 | 2.8% |
| | | regulator (1) | by weight | | | | | |
| Example 2 | 2.4 | retardation | 14 parts | 57087 | 127.0 | 130.8 | 1.01 | 3.0% |
| | | regulator (1) | by weight | | | | | |
| Example 3 | 2.4 | Retardation | 20 parts | 49862 | 140.2 | 140.5 | 1.01 | 4.5% |
| | | regulator (1) | by weight | | | | | |
| Example 4 | 2.4 | retardation | 10 parts | 41532 | 181.0 | 183.2 | 1.01 | 1.5% |
| | | regulator (2) | by weight | | | | | |
| Example 5 | 2.4 | retardation | 13 parts | 52755 | 156.3 | 157.3 | 1.01 | 2.0% |
| | | regulator (3) | by weight | | | | | |
| Example 6 | 2.4 | retardation | 14 parts | 66685 | 124.7 | 130.0 | 1.02 | 0.5% |
| | | regulater (4) | by weight | | | | | |
| Comparative | 2.87 | retardation | 15 parts | 48560 | 98.2 | 96.2 | 0.98 | 2.2% |
| Example 1 | | regulater (1) | by weight | | | | | |
| Comparative | 2.4 | — | — | 180000 | 80.4 | 86.7 | 1.03 | 0.9% |
| Example 2 | | | | | | | | |

As seen from the above Table 1, Examples 1 to 6 of the present invention show inverse wavelength dispersion, respectively, with the addition of the additive in the range of 10-20 parts by weight, have high retardation in a thickness direction, low water vapor transmission rate, and thus, are appropriate for being used as an optical film. Comparative Example 1 used cellulose triacetate resin having a substitution degree of 2.87, and as a result, it was seen that the film had Rₜₕ(650)/Rₜₕ(550) value of 0.98, and did not show inverse wavelength dispersion. In addition, Comparative Example 2 used cellulose triacetate resin having a substitution degree of 2.4 without adding any additive to prepare film, and it was seen that the film had water vapor transmission rate of 180000 g·μm/m²·day which is very high.

The cellulose acylate film according to the present invention uses cellulose acylate resin having a low substitution degree, and a specific additive. Thus, the cellulose acylate film for an optical film having a water vapor transmission rate appropriate for using as an optical film and high retardation of film, and satisfying inverse wavelength dispersion is provided using cellulose acylate resin having a low substitution degree.

In addition, the cellulose acylate film according to the present invention uses cellulose acylate resin having a low substitution degree, thereby being effective in cost reduction.

What is claimed is:

1. A cellulose acylate film, comprising a cellulose acylate resin having a substitution degree of hydroxyl group of 2.0 to 2.6 per 1 unit of cellulose, and having a water vapor transmission rate of 70,000 g˜μn/m²·day or less, and a retardation in a thickness direction (Rₜₕ(λ)) satisfying the following Equation 1:
100<Rₜₕ(550)<300 [Equation 1]
wherein, Rₜₕ(λ) is a retardation value (nm) in the direction of the film thickness at a wavelength of λnm.

2. The cellulose acylate film of claim 1, wherein the retardation in a thickness direction (Rₜₕ(λ)) satisfies the following Equation 2:
Rₜₕ(650)/Rₜₕ(550)>1
Rₜₕ(550)−Rₜₕ(650)<Rₜₕ(550)−Rₜₕ(450) [Equation 2]
wherein, Rₜₕ(λ) is a retardation value (nm) in the direction of the film thickness at a wavelength of λnm.

3. The cellulose acylate film of claim 1, wherein it has a mass change less than 5% after heat treatment at 110° C. for 500 hours.

4. The cellulose acylate film of claim 1, wherein the cellulose acylate resin has a substitution degree of 2.2 to 2.45.

5. The cellulose acylate film of claim 4, wherein the cellulose acylate resin has the substitution degree satisfying the following Equation 3:
2.2≦DSac+DSap+DSab≦2.45 [Equation 3]
wherein, DSac is a substitution degree of acetyl group, DSap is a substitution degree of propionyl group, and DSab is a substitution degree of butyryl group.

6. The cellulose acylate film of claim 1, wherein it has a water vapor transmission rate of 40,000˜60,000 g·μm/m²·day.

7. The cellulose acylate film of claim 1, comprising a retardation regulator of any one or more selected from the following Chemical Formula 1 in an amount of 10 to 50 parts by weight, based on 100 parts by weight of the cellulose acylate resin:
Ar—[Q]ₘ [Chemical Formula 1]
wherein,
Ar is (C6-C20)aryl or (C3-C20)heteroaryl, and may be further substituted by one or more selected from halogen, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group, (C6-C20)aryloxycarbonyl group, (C1-C20)alkylacyloxy group, (C6-C20)arylacyloxy group, sulfonylamino group, nitro, hydroxyl group, cyano group, amino group, acylamino group, and 5- to 7-membered heterocycloalkyl containing one or more elements selected from Q, N, O and S;
Q is 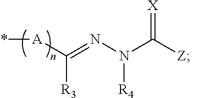
A is 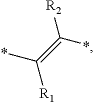
wherein R₁ and R₂ are hydrogen, halogen, hydroxy, (C1-C20) alkyl or (C3-C20)heterocycloalkyl, respectively;
R₃ is hydrogen, halogen, hydroxy, (C1-C20)alkyl, (C1-C20)alkylcarbonyl, (C6-C20)allyl, (C3-C20)heteroaryl or (C3-C20)heterocycloalkyl, and R₃ and Ar may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
R₄ is hydrogen or (C1-C20)alkyl;
X is O or S;
Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
n is an integer of 0 to 3;
m is an integer of 1 to 10; and
alkyl and heterocycloalkyl of R₁ to R₃, alkyl of R₄, alkyl of Z, alkyl of R₁₁ to R₁₃, and alicyclic ring or aromatic ring of Z and R₃ may be independently of one another further substituted by one or more selected from halogen, nitro, cyano, hydroxy, amino, (C1-C20)alkyl, (C1-C20)alkoxy, (C2-C20)alkenyl, (C3-C20)cycloalkyl, 5- to 7-membered heterocycloalkyl containing one or more elements selected from N, O and S.

8. The cellulose acylate film of claim 7, wherein
R₁ and R₂ are hydrogen, respectively;
R₃ is hydrogen, (C1-C20)alkyl or (C1-C20)alkylcarbonyl;
R₄ is hydrogen or (C1-C20)alkyl;
X is O or S;
Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
n is an integer of 0 to 3;
m is an integer of 1 to 10; and
alkyl and heterocycloalkyl of R₁ to R₃, alkyl of R₄, alkyl of Z, and alkyl of R₁₁ to R₁₃ may be independently of one another further substituted by one or more selected from halogen, nitro, cyano, hydroxy, amino, (C1-C20)alkyl, (C1-C20)alkoxy, (C2-C20)alkenyl, (C3-C20)cycloalkyl, 5- to 7-membered heterocycloalkyl containing one or more elements selected from N, O and S.

9. The cellulose acylate film of claim 7, wherein the Chemical Formula 1 is represented by the following Chemical Formulae 2 and 3: 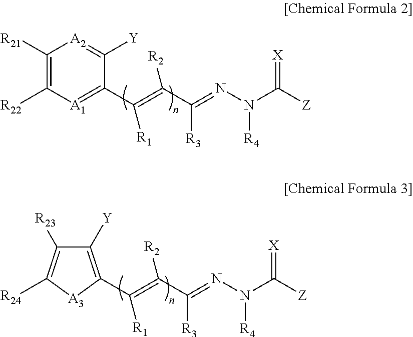
wherein,
R₁ and R₂ are hydrogen, halogen, hydroxy, (C1-C20)alkyl or (C3-C20)heterocycloalkyl, respectively;
R₃ is hydrogen, halogen, hydroxy, (C1-C20)alkyl or (C3-C20)heterocycloalkyl, and R₃ and Ar may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
R₄ is hydrogen or (C1-C20)alkyl;
X is O or S;
Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
n is an integer of 0 to 3;
A₁ or A₂ are independently of each other CR₇ or N;
A₃ is O, S or NR₈, wherein R₈ is hydrogen or (C1-C20)alkyl;
Y is selected from hydrogen, —N(R₃₁R₃₂), —O(R₃₃), —S(R₃₄) or —P═O(R₃₅) (R₃₆), wherein R₃₁ to R₃₆ are independently of one another hydrogen or (C1-C20)alkyl; and
R₂₁ to R₂₄ and R₇ are independently of one another selected from hydrogen, halogen, Q, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group (C6-C20)aryloxycarbonyl group, (C1-C20)alkylacyloxy group, (C6-C20)arylacyloxy group, sulfonylamino group, hydroxyl group, cyano group, amino group, acylamino group and 5- to 7-membered heterocycloalkyl containing one or more elements selected from N, O and S.

10. The cellulose acylate film of claim 9, wherein
R₁ and R₂ are hydrogen, respectively;
R₃ is hydrogen, (C1-C20)alkyl or (C1-C20)alkylcarbonyl;
R₄ is hydrogen or (C1-C20)alkyl;
X is O or S;
Z is (C1-C20)alkyl group, —N(R₁₁R₁₂) or —O(R₁₃), wherein R₁₁ to R₁₃ are independently of one another selected from hydrogen and (C1-C20)alkyl, and R₁₁ and R₁₂ may be linked by substituted or unsubstituted (C3-C20)alkylene, or substituted or unsubstituted (C3-C20)alkenylene containing or not containing a fused ring to form an alicyclic ring and a monocyclic or polycyclic aromatic ring, wherein the carbon atom of the formed alicyclic ring and monocyclic or polycyclic aromatic ring may be substituted by one or more heteroatoms selected from nitrogen, oxygen and sulfur;
n is an integer of 0 to 3;
A₁ or A₂ is independently of each other CR₇ or N;
A₃ is O, S or NR₈, wherein R₈ is hydrogen or (C1-C20)alkyl;
Y is selected from hydrogen, —N(R₃₁R₃₂), —O(R₃₃), —S(R₃₄) or —P═O(R₃₅)(R₃₆), wherein R₃₁ to R₃₆ are independently of one other hydrogen or (C1-C20)alkyl; and
R₂₁ to R₂₄ and R₇ are independently of one another selected from hydrogen, halogen, Q, (C1-C20)alkyl, (C3-C20)cycloalkyl, (C1-C20)alkoxy, (C6-C20)aryloxy, (C1-C20)alkylacyl group, (C6-C20)arylacyl group, (C1-C20)alkoxycarbonyl group, (C6-C20)aryloxycarbonyl group, (C1-C20)alkylacyloxy group, (C6-C20)arylacyloxy group, sulfonylamino group, hydroxyl group, cyano group, amino group, acylamino group, and 5- to 7-membered heterocycloalkyl containing one or more elements selected from N, O and S.

11. The cellulose acylate film of claim 7, wherein the compound of the Chemical Formula 1 is selected from the following structures:

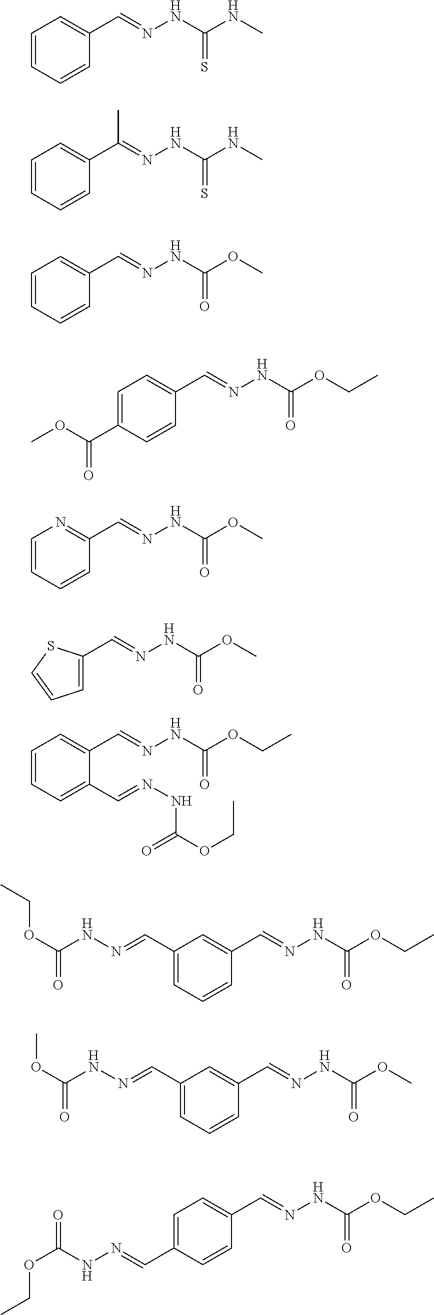

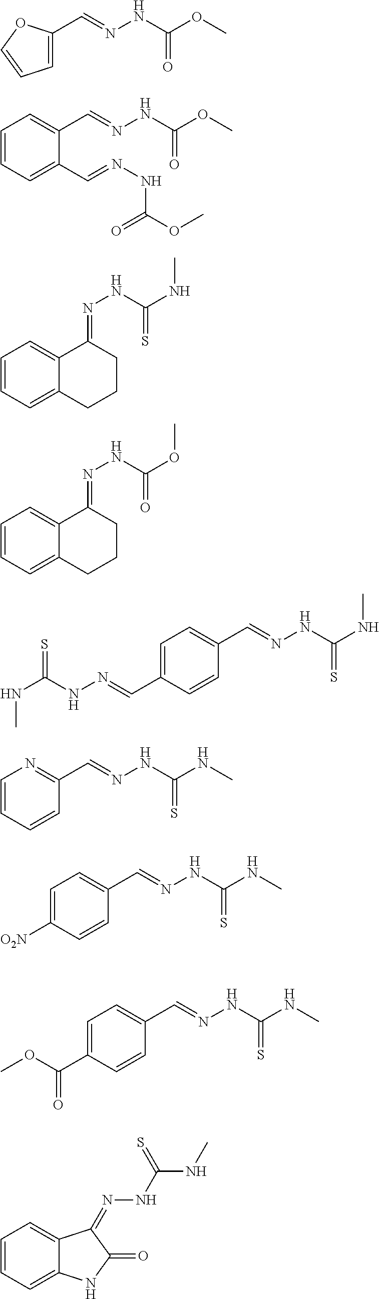

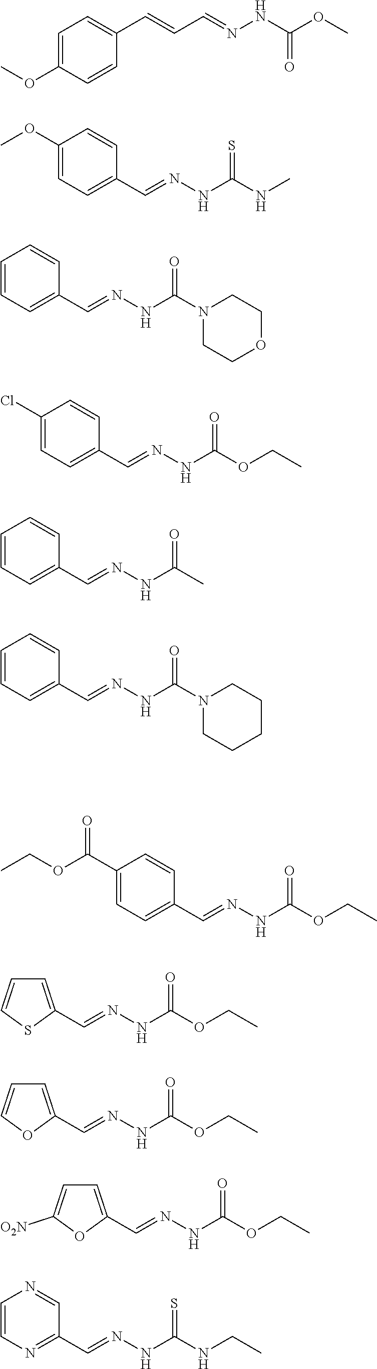

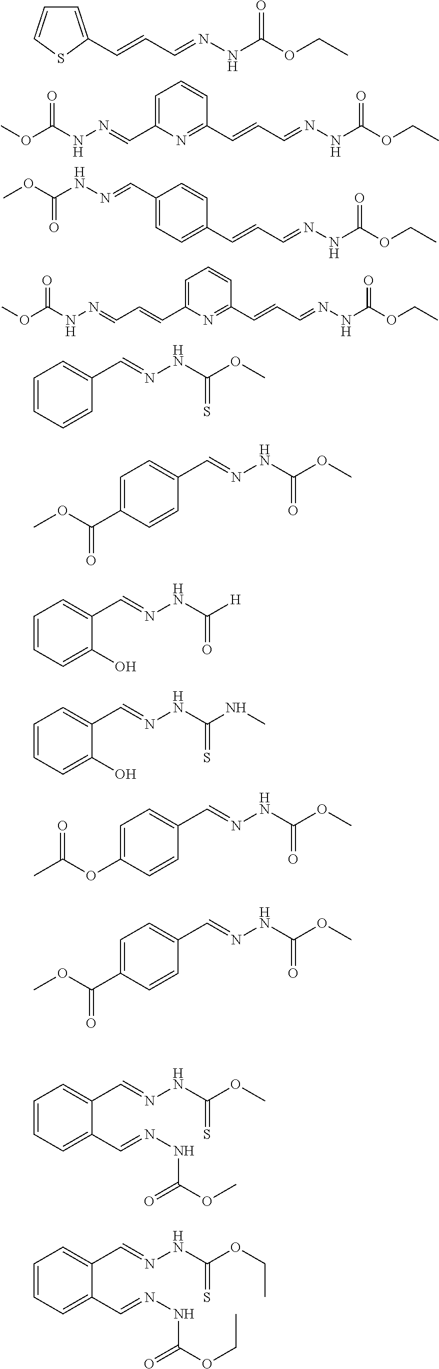

12. The cellulose acylate film of claim 7, wherein the compound of the Chemical Formula 1 has a molecular weight of 300 to 1000.

13. The cellulose acetate film of claim 1, wherein it is used in optical compensation sheet, an optical filter for stereoscopic images, a polarizer and a liquid crystal display.

14. A display comprising the cellulose acylate film of claim 1.
